(19) United States
(12) Patent Application Publication
(10) Pub. No.: US 2026/0070583 A1
(43) Pub. Date: Mar. 12, 2026

(54) SYSTEM AND METHOD FOR DETERMINING BLOCKED LANES IN ACTIVE WORK ZONES BY AN AUTONOMOUS VEHICLE

(71) Applicant: Torc Robotics, Inc., Blacksburg, VA (US)

(72) Inventors: Savio Pereira, Austin, TX (US); Akshay Pai Raikar, Austin, TX (US); Joseph R. Fox-Rabinovitz, Austin, TX (US)

(21) Appl. No.: 18/882,025

(22) Filed: Sep. 11, 2024

(51) Int. Cl. B60W 60/00; B60W 50/14; G06N 3/044

(52) U.S. Cl. CPC B60W 60/0015; B60W 50/14; G06N 3/044; B60W 2050/146; B60W 2554/4042; B60W 2554/4046; B60W 2554/80

(57) ABSTRACT

An autonomous vehicle that determines blocked lanes in occluded active work zones and performing maneuvers around the active work zones is provided. The autonomous vehicle includes at least one sensor configured to capture heuristic data about an environment in which the autonomous vehicle is operating. The autonomous vehicle further includes at least one memory device configured to store machine executable instructions and at least one processor coupled to the at least one memory device. Upon executing the machine executable instructions, at least one processor is configured to: receive the heuristic data captured by the at least one sensor, determine, using a blockage inference machine learning (ML) model, the one or more blocked lanes exists (with the heuristic data as inputs), and initiate a maneuver of the autonomous vehicle around the one or more blocked lanes.

### TECHNICAL FIELD

The field of the disclosure relates generally to autonomous vehicles and, more specifically, to determining blocked lanes in active work zones and performing maneuvers of an autonomous vehicle around the active work zones.

### BACKGROUND OF THE INVENTION

During construction or other road closure events, some or all of the lanes of a road may be blocked. In such situations, vehicles may be expected to navigate to another lane that is not blocked or determine an alternative route. For a conventional vehicle, an operator of the vehicle ascertains that the blockage exists and determines actions to avoid the blockage. In known methods for an autonomous vehicle, the determination relies on sensor data acquired by sensors equipped with the autonomous vehicle. However, the field of view of sensors may be occluded, for example, by one or more other vehicles or traffic in the roadway. Accordingly, there is a need for systems and methods for detecting blockage when the blockage is at least partially occluded from at least one field of view of sensors.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, an autonomous vehicle is provided. The autonomous vehicle includes at least one sensor configured to capture heuristic data about an environment in which the autonomous vehicle is operating. The heuristic data includes contextual data about a blockage caused by one or more blocked lanes in the environment while the one or more blocked lanes are at least partially occluded from at least one field of view of the at least one sensor. The autonomous vehicle further includes at least one memory device configured to store machine executable instructions and at least one processor coupled to the at least one memory device. Upon executing the machine executable instructions, at least one processor is configured to: receive the heuristic data captured by the at least one sensor, determine, using a blockage inference machine learning (ML) model, the one or more blocked lanes exists, with the heuristic data as inputs, and initiate a maneuver of the autonomous vehicle around the one or more blocked lanes.

In yet another aspect, a computer-implemented method for detecting one or more blocked lanes for an autonomous vehicle is provided. The method includes receiving heuristic data captured by at least one sensor of an autonomous vehicle, the heuristic data being about an environment in which the autonomous vehicle is operating, and the heuristic data including contextual data about a blockage caused by one or more blocked lanes in the environment while the one or more blocked lanes are at least partially occluded from at least one field of view of the at least one sensor. The method further includes determining, using a blockage inference ML model, the one or more blocked lanes exists, with the heuristic data as inputs and initiating a maneuver of the autonomous vehicle around the one or more blocked lanes.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic diagram of an autonomous vehicle;

FIG. 2 is a block diagram of an autonomous vehicle;

FIG. 3 is a block diagram of an example blockage inference ML framework;

FIG. 4 is a block diagram of an example architecture of the blockage inference ML framework of FIG. 3;

FIG. 5 is a flowchart of an example method of detecting blocked lanes for an autonomous vehicle;

FIG. 6A is a block diagram of an example neural network;

FIG. 6B is a block diagram of an example neural network; and

FIG. 7 is a block diagram of an example computing device.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

The provided systems and methods are described, for clarity, using certain terminology when referring to and describing relevant components within the disclosure. Where possible, common industry terminology is employed in a manner consistent with its accepted meaning. Unless otherwise stated, such terminology should be given a broad interpretation consistent with the context of the present application and the scope of the appended claims.

Embodiments of the provided systems determine, using a machine learning (ML) model, a maneuver for an autonomous vehicle in situations where forward travel lanes of a road on which the autonomous vehicle is traveling are at least partially blocked, using heuristic data received from one or more sensors of the autonomous vehicle, where fields of view of sensors are at least partially occluded from the blockage. As used herein, heuristic data are data about the environment in which the autonomous vehicle is operating and include contextual data about a blockage caused by one or more blocked lanes in the environment while the one or more blocked lanes are at least partially occluded from at least one field of view of the at least one sensor. The autonomous vehicle may include or otherwise be in communication with an example blockage inference ML model. The blockage inference ML model is configured to determine, using the heuristic data collected from a plurality of sources (e.g., including the one or more sensors of the autonomous vehicle), whether a lane blockage is imminent, and information related to the upcoming blockage. The heuristic data may include, for example, traffic patterns ahead of the ego or the autonomous vehicle(e.g., in the ego lane), detected construction signage, detected construction objects in adjacent lanes, or other contextual data that may indicate that a lane or a portion of a road is closed ahead.

Systems described herein are configured to first receive the heuristic data captured by the at least one sensor of the autonomous vehicle. In other embodiments, heuristic data may be captured by other external sensors not of the autonomous vehicle or may be external data provided to an autonomy computing system of the autonomous vehicle via a wireless transmission or communication system such as GPS data, radio transmission, etc. Additionally, in embodiments provided herein, the heuristic data are input into the blockage inference ML model and assigned weights by the blockage inference ML model. For example, first heuristic data of a traffic sign stating “work zone” may be weighted more heavily than second heuristic data of a turn signal of a vehicle in front of the autonomous vehicle captured by at least one sensor of the autonomous vehicle. The blockage inference ML model, after assigning the weights, then evaluates the weighted heuristic data to determine: (1) whether a blockage in the upcoming roadway exists, and (2) metrics related to the blockage (e.g., how far away the blockage is from the ego, etc.). Based on the determination made by the blockage inference ML model, the vehicle autonomy computing system initiates a maneuver of the autonomous vehicle around the one or more blocked lanes, to ensure the safety of all vehicles, drivers, and road workers sharing the roadway.

If the autonomous vehicle cannot accurately predict or foresee a lane blockage or closure in advance, the ability to perform a maneuver ahead of the blockage decreases significantly. The more time the autonomous vehicle has to be aware of the upcoming lane closure, the safer the corresponding action taken can be. For a conventional vehicle, a human operator of the vehicle determines the blockage exists and actions to avoid the blockage. In known methods for an autonomous vehicle, the determination relies on sensor data acquired by sensors equipped with the autonomous vehicle. However, when the fields of view of sensors are occluded from the blocked lanes, sensor data of the blocked lanes are unavailable or the sensor data do not provide sufficient confidence for the autonomous vehicle to determine blockage. In such situations, the blockage may not be detected until the autonomous vehicle is at a location proximate to the blockage of lanes, leaving insufficient time or distance to maneuver the autonomous vehicle around the blockage. Consequently, emergency maneuvers of the autonomous vehicle are triggered, resulting in jerky operation of the autonomous vehicle and potential damages to the autonomous vehicle. The systems and methods provided herein are advantageous in addressing the problem caused by occlusion in the fields of view of sensors by analyzing heuristic data including contextual data using a machine learning model to predict road blockages and to accordingly initiate maneuvers of the autonomous vehicle around the road blockages.

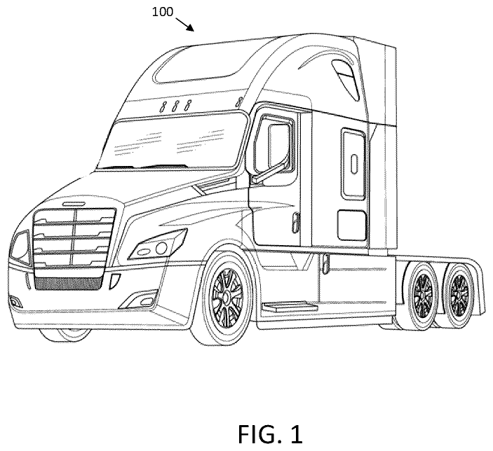

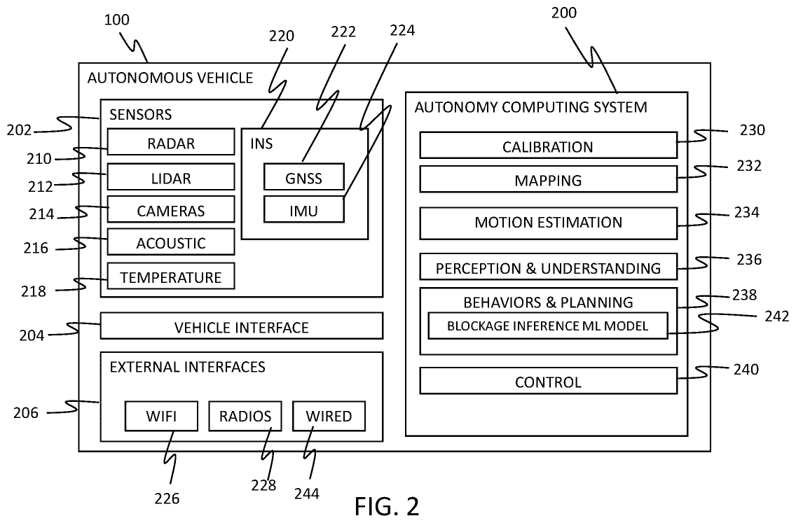

FIG. 1 is a schematic diagram of an autonomous vehicle 100. FIG. 2 is a block diagram of an autonomous vehicle 100 shown in FIG. 1. In the example embodiment, the autonomous vehicle 100 includes an autonomy computing system 200, sensors 202, a vehicle interface 204, and external interfaces 206.

In the example embodiment, the sensors 202 may include various sensors such as, for example, radio detection and ranging (RADAR) sensors 210, light detection and ranging (LiDAR) sensors 212, cameras 214, acoustic sensors 216, temperature sensors 218, or an inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. The sensors 202 generate respective output signals based on detected physical conditions of the autonomous vehicle 100 and its proximity. As described in further detail below, these signals may be used by the autonomy computing system 200 to determine how to control operation of the autonomous vehicle 100.

The cameras 214 are configured to capture images of the environment surrounding the autonomous vehicle 100 in any aspect or field of view (FOV). The FOV can have any angle or aspect such that images of the areas ahead of, to the side, behind, above, or below the autonomous vehicle 100 may be captured. In some embodiments, the FOV may be limited to particular areas around the autonomous vehicle 100 (e.g., forward of the autonomous vehicle 100, to the sides of the autonomous vehicle 100, etc.) or may surround 360 degrees of the autonomous vehicle 100. In some embodiments, the autonomous vehicle 100 includes multiple cameras 214, and the images from each of the multiple cameras 214 may be stitched or combined to generate a visual representation of the multiple cameras' FOVs, which may be used to, for example, generate a bird's eye view of the environment surrounding the autonomous vehicle 100. In some embodiments, the image data generated by the cameras 214 may be sent to the autonomy computing system 200 or other aspects of the autonomous vehicle 100, and this image data may include the autonomous vehicle 100 or a generated representation of the autonomous vehicle 100. In some embodiments, one or more systems or components of the autonomy computing system 200 may overlay labels to the features depicted in the image data, such as on a raster layer or other semantic layer of a high-definition (HD) map.

The LiDAR sensors 212 generally include a laser generator and a detector that send and receive a LiDAR signal such that LiDAR point clouds (or “LiDAR images”) of the areas ahead of, to the side, behind, above, or below the autonomous vehicle 100 can be captured and represented in the LiDAR point clouds. The radar sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw radar sensor data) from the emitted radio waves. In some embodiments, the system inputs from the cameras 214, the radar sensors 210, or the LiDAR sensors 212 may be fused or used in combination to determine conditions (e.g., locations of other objects) around autonomous vehicle 100.

The GNSS receiver 222 is positioned on the autonomous vehicle 100 and may be configured to determine a location of the autonomous vehicle 100, which it may embody as GNSS data, as described herein. The GNSS receiver 222 may be configured to receive one or more signals from a global navigation satellite system (e.g., Global Positioning System (GPS) constellation) to localize the autonomous vehicle 100 via geolocation. In some embodiments, the GNSS receiver 222 may provide an input to or be configured to interact with, update, or otherwise utilize one or more digital maps, such as an HD map (e.g., in a raster layer or other semantic map). In some embodiments, the GNSS receiver 222 may provide direct velocity measurement via inspection of the Doppler effect on the signal carrier wave. Multiple GNSS receivers 222 may also provide direct measurements of the orientation of the autonomous vehicle 100. For example, with two of the GNSS receivers 222, two attitude angles (e.g., roll and yaw) may be measured or determined. In some embodiments, the autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about the autonomous vehicle 100 and its environment.

The IMU 224 is a micro-electrical-mechanical (MEMS) device that measures and reports one or more features regarding the motion of the autonomous vehicle 100, although other implementations are contemplated, such as mechanical, fiber-optic gyro (FOG), or FOG-on-chip (SiFOG) devices. The IMU 224 may measure an acceleration, angular rate, and or an orientation of the autonomous vehicle 100 or one or more of its individual components using a combination of accelerometers, gyroscopes, or magnetometers. The IMU 224 may detect linear acceleration using one or more accelerometers and rotational rate using one or more gyroscopes and attitude information from one or more magnetometers. In some embodiments, the IMU 224 may be communicatively coupled to one or more other systems, for example, the GNSS receiver 222 and may provide input to and receive output from the GNSS receiver 222 such that the autonomy computing system 200 is able to determine the motive characteristics (acceleration, speed/direction, orientation/attitude, etc.) of the autonomous vehicle 100.

In the example embodiment, the autonomy computing system 200 employs the vehicle interface 204 to send commands to the various aspects of the autonomous vehicle 100 that actually control the motion of the autonomous vehicle 100 (e.g., engine, throttle, steering wheel, brakes, etc.) and to receive input data from one or more of the sensors 202 (e.g., internal sensors). The external interfaces 206 are configured to enable the autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, the external interfaces 206 may be configured to communicate with an external network via a wired connection 244, such as, for example, during testing of the autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by the autonomous vehicle 100 to navigate or otherwise operate, either autonomously or semi-autonomously. The digital files, executable programs, and other computer readable code may be stored locally or remotely and may be routinely updated (e.g., automatically or manually) via the external interfaces 206 or updated on demand. In some embodiments, the autonomous vehicle 100 may deploy with all of the data it needs to complete a mission (e.g., perception, localization, and mission planning) and may not utilize a wireless connection or other connection while underway.

In the example embodiment, the autonomy computing system 200 is implemented by one or more processors and memory devices of the autonomous vehicle 100. The autonomy computing system 200 includes modules, which may be hardware components (e.g., processors or other circuits) or software components (e.g., computer applications or processes executable by the autonomy computing system 200), configured to generate outputs, such as control signals, based on inputs received from, for example, the sensors 202. These modules may include, for example, a calibration module 230, a mapping module 232, a motion estimation module 234, a perception and understanding module 236,ehaveiors and planning module 238, a control module or controller 240, and a blockage inference ML model 242. In the example embodiment, the perception and understanding module 236 includes an occlusion library (not shown), which is configured to determine regions of occlusion from the field of view of one or more of the sensors 202. The blockage inference ML model 242, for example, may be embodied within another module, such as the behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard the autonomous vehicle 100.

The behaviors and planning module 238 maintains proper lane position for the autonomous vehicle 100 in all conditions, e.g., regardless of signage for given road conditions. The behaviors and planning module 238 receives, for example, positions of left or right lane markings from the perception and understanding module 236 and computes a lane position offset from the identified lane marking. Where both left and right lane markings are detected by the perception and understanding module 236, in combination with the sensors 202, the behaviors and planning module 238 selects one lane marking from which lane positioning is derived.

The autonomy computing system 200 of the autonomous vehicle 100 may be completely autonomous (fully autonomous) or semi-autonomous. In one example, the autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

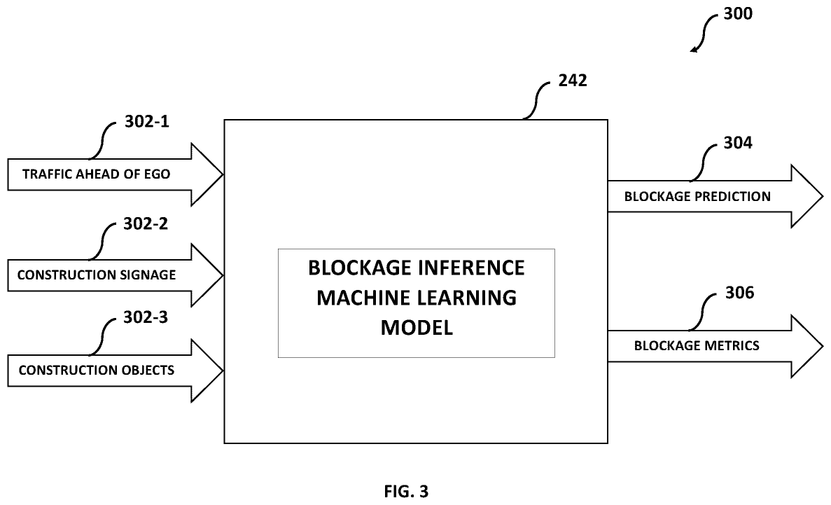

FIG. 3 is a block diagram of an example blockage ML framework 300. In the example embodiment, the blockage inference ML framework 300 includes the blockage inference ML model 242 of FIG. 2. The framework 300 includes heuristic data 302. The heuristic data 302 are input to the blockage inference ML model 242. The outputs of the blockage inference ML model include a blockage prediction 304. The outputs of the blockage inference ML model may further include blockage metrics 306.

The heuristic data 302 may be of one or more types. For example, the framework 300 includes first heuristic data 302-1, second heuristic data 302-2, third heuristic data 302-3. In the depicted embodiment, the first heuristic data 302-1 is data related to traffic ahead of the ego, such as turn signal indicators of vehicles in front of the autonomous vehicle, trajectories of traffic vehicles in the adjacent lane, speed of traffic relative to the speed limit, speed of traffic relative to traffic in adjacent lanes, etc. Turn signal states of traffic in the lane ahead of the ego likely indicate that those vehicles are attempting to move out of an upcoming blocked lane. Trajectories of vehicles in the lane adjacent to the ego may also indicate an upcoming lane blockage in instances wherein these vehicles are attempting to move out of an upcoming blocked lane without first turning on turn signal indicators. In these cases, the trajectory of the vehicle is a better indicator of whether the vehicle is changing lanes. For example, an evaluation of whether the vehicle trajectory intersects the lane boundary line may indicate movement of a vehicle in response to an upcoming blocked lane. Furthermore, in the example embodiment, a speed of traffic relative to the speed limit or to traffic in adjacent lanes may indicate an upcoming lane blockage, because a slowing of traffic, is likely to indicate that the vehicles are decreasing the speed to avoid an upcoming blockage.

In the example embodiment, the second heuristic data 302-2 include data related to construction signage, such as “active work zone” signs, traffic cones, or lane merging signs. Construction signage indicates that road construction is proximate or upcoming. For example, in fortuitous circumstances, the sensors 202 may be able to detect a sign that directly indicates that the upcoming lane or roadway is blocked. However, such a circumstance is uncommon and cannot always be relied upon solely, as it is possible that the construction signs may not have been set up before the existence of the blockage. Furthermore, it is also possible that such construction signage may not be accurately detected by the sensors 202 of FIG. 2 due to occlusions of a field of view.

In the example embodiment, the third heuristic data 302-3 include data related to detected construction objects in adjacent lanes. Construction objects may be visible or partially visible in the adjacent lane(s). The presence of construction objects indicates a relatively high likelihood of blockage and may be relied upon to infer the existence of one or more upcoming blocked lanes.

In some embodiments, the inputs to the blockage inference ML model 242 include other types of heuristic data, such as traffic data received from mission control.

In the example embodiment, the heuristic data 302 are input into the blockage ML model 242 to determine a blockage exists. Although the heuristic data 302 may indicate a blockage, the heuristic data 302 may not be a clear and reliable indicator of the blockage. The blockage inference ML model 242 is used to determine the blockage based on the heuristic data 302. Using a ML model, instead of an analytical or rule-based algorithm, is advantageous in increasing the accuracy and speed of the determination because using a rule-based algorithm may be computation expensive and difficult to implement to include every possible scenario. The heuristic data 302 are weighted by the blockage inference ML model 242. Weighting the heuristic data 302 by the blockage inference ML model 242 is advantageous because weighing heuristic data manually and/or with a predefined weight is labor intensive and error-prone due to the fact that each type or subtype of heuristic data may have a different weighting and the weighting may change for different situations of the autonomous vehicle.

In the example embodiment, the blockage prediction 304 is part of the output produced by the blockage inference ML model 242. The blockage prediction 304 indicates whether the model has predicted that a blockage exists in the roadway ahead. Additionally, the outputs from the blockage inference ML model 242 may further include the predicted blockage metrics 306. The predicted blockage metrics 306 may include metrics determined by the blockage inference ML model 242. The predicted blockage metrics 306 may include the distance between the autonomous vehicle 100 and the blockage ahead, the velocity of the autonomous vehicle 100, etc. The predicted blockage metrics 306 may also include a confidence score output by the blockage inference ML model 242, which indicates the confidence level of the output predicted by the model. The confidence score may be evaluated by the autonomy computing system 200 in determining a maneuver of the autonomous vehicle 100 around the predicted blockage.

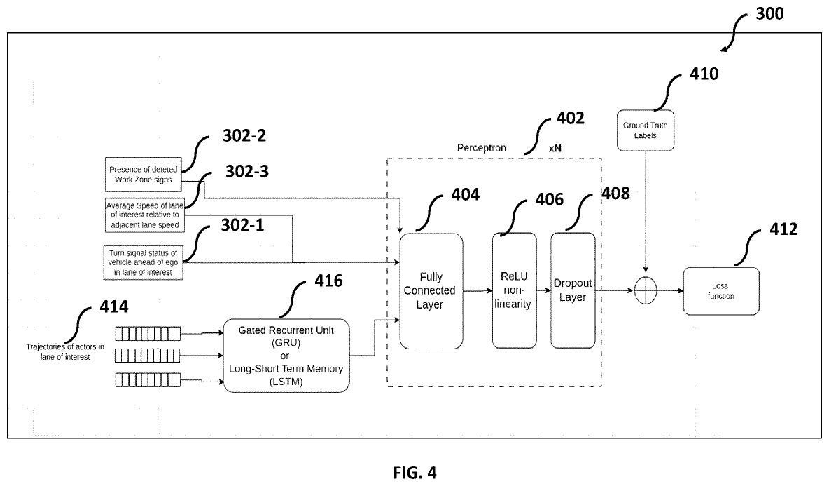

The blockage inference ML model 242 may be trained using supervised training. In some embodiments, the blockage inference ML model 242 may be trained using unsupervised training. The blockage inference ML model 242 are trained with training data, such as annotated safety data. In the example embodiment, in order to obtain the ground truth (e.g., ground truth 410 of FIG. 4, described later) that will be used to train the ML model, data are collected from the sensors 202 when the autonomous vehicle 100 is driving past active work zones. While the autonomous vehicle 100 is driving past the active work zones, an operator annotates whether a blockage was present once the autonomous vehicle 100 has passed the active work zone. In order to collect the ground truth data, the autonomous vehicle 100 is manually operated by a driver who is also accompanied by an annotator riding alongside the driver (e.g., in the passenger seat).

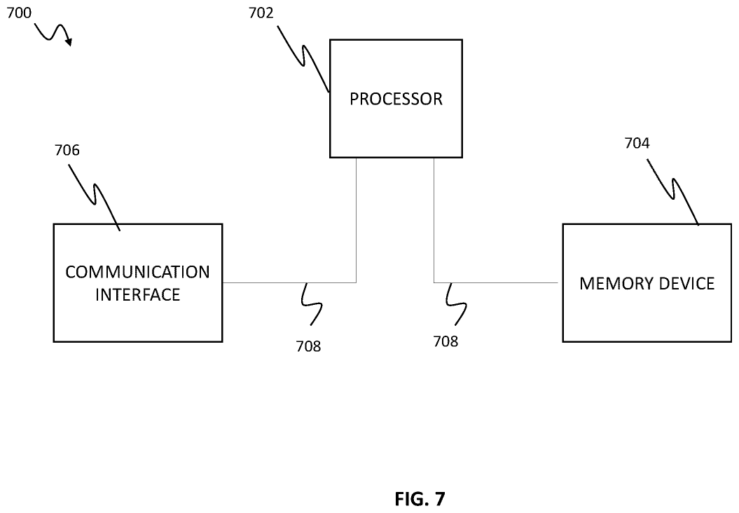

In the example embodiment, during the manual runs collecting training data, all the sub-systems and modules within the autonomy computing system 200 of the autonomous vehicle 100 will be running. However, the control outputs are not sent to the physical actuators of the autonomous vehicle 100. Instead, the outputs of sub-systems and/or module are recorded onto a storage device on the autonomous vehicle 100, such as the memory device 704 described later in conjunction with FIG. 7. The outputs of the autonomy computing system 200, especially the outputs from the mapping module 232 and the perception and understanding module 236, include data for training, because the outputs provide information about the input features to the blockage inference ML model 242, such as the trajectories of other vehicles, turn signal statuses of other vehicles, map geometry, detected construction signage, etc.

In obtaining the ground truth labels (e.g., ground truth 410), the annotator may mark (e.g., on a front-end Web Application) which lanes are blocked by construction work. In some embodiments, the web application that the annotator utilizes during the manual runs can be run on a tablet, a laptop computer, a PC, or any other types of portable computing device. In some embodiments, the portable computing device may have touchscreen functionality. In the example embodiment, the web application utilized by the annotator displays (e.g., in real-time) the lanes of travel along the current route of the autonomous vehicle and provides the annotator with an option to mark any given lane as blocked. As used herein, “real-time” refers to the displays being presented to the annotator without noticeable delay while the autonomous vehicle is operating. The timestamp at which the annotator marks a lane as blocked is used to generate ground truth values for the distance to upcoming blockage metric, upon which the blockage inference ML model 242 is trained.

FIG. 4 is a block diagram of an example architecture of the blockage inference machine learning (ML) framework 300. In the example embodiment, The blockage inference ML framework 300 is an example Recurrent Neural network (RNN) designed to encode trajectories 414 of vehicles and/or other objects of interest on the roadway. An RNN is advantageous in processing and providing inferences from sequential data, for example the heuristic data 302, which are sequential in the temporal dimension. The trajectories 414 of vehicles may be stored in an example memory storage 416, such as a Gated Recurrent Unit (GRU) or a Long-Short Term Memory (LSTM). However, in other embodiments, any other type of neural network or memory storage unit may be utilized. Furthermore, the blockage inference ML framework further includes a series of perceptron layers 402. A perceptron layer 402 may include an example fully connected layer 404, an example Rectified Linear Unit (ReLU) layer 406, and/or an example dropout layer 408.

In the example embodiment, the fully connected layer 404 connects every input neuron to every output neuron. Furthermore, the ReLU layer 406 enables the neural network (e.g., the blockage inference ML model 242) to model non-linearities. Additionally, the dropout layer 408 limits the machine learning model (e.g., the blockage inference ML model 242) from overfitting the training data. The outputs from the perceptron layers 402, are evaluated by the blockage inference ML model 242 against the ground truth 410, to compute a loss function 412, to evaluate the accuracy of the neural network model.

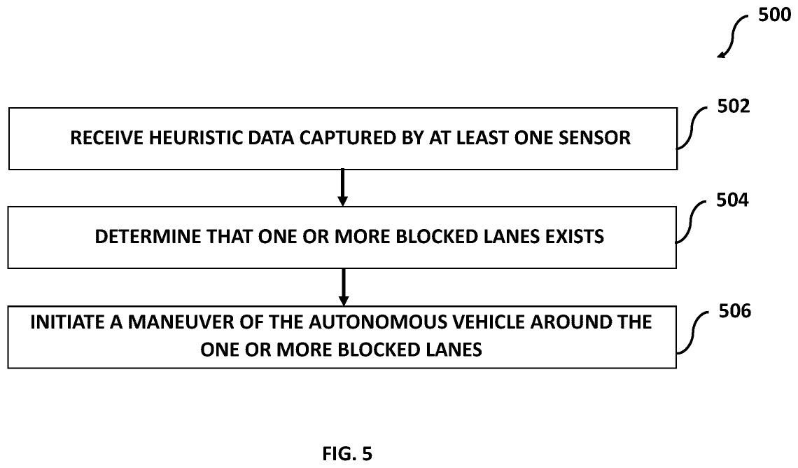

FIG. 5 is a flowchart of an example method 500 of determining lane blockage for an autonomous vehicle. Part or all elements of the method 500 may be implemented with the autonomy computing system 200 (see FIG. 2). The method 500 includes receiving 502 heuristic data captured by at least one sensor of the autonomous vehicle 100. The method 500 further includes determining 504, using a blockage inference ML model, that one or more blocked lanes exist. An example blockage inference ML model is blockage inference ML model 242 described herein. The method 500 also includes initiating 506 a maneuver of the autonomous vehicle 100 around the one or more blocked lanes.

In some embodiments, the perception and understanding module 236 configured to determine occlusion and regions of occlusion from fields of view of sensors 202. based on field of views of sensors and surrounding objects. The perception and understanding module 236 includes a library or utility (e.g., an occlusion library or an occlusion utility) that may be queried with a 2-D polygon region. In these embodiments, the occlusion library returns the portion of the region that is currently occluded. In these embodiments, for the lane of the roadway along which the autonomous vehicle 100 is traveling, the perception and understanding module 236 constructs a polygon encompassing the lane and passes the polygon as a query to the occlusion library. The occlusion library then outputs the region of the lane that is currently occluded.

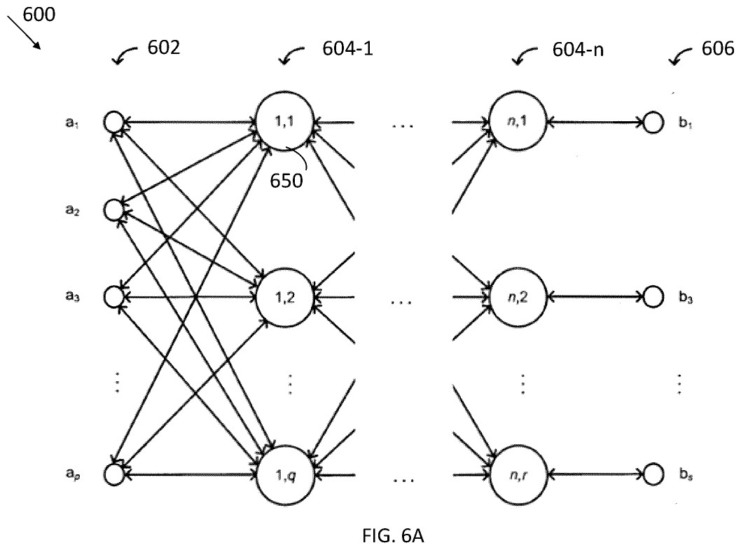

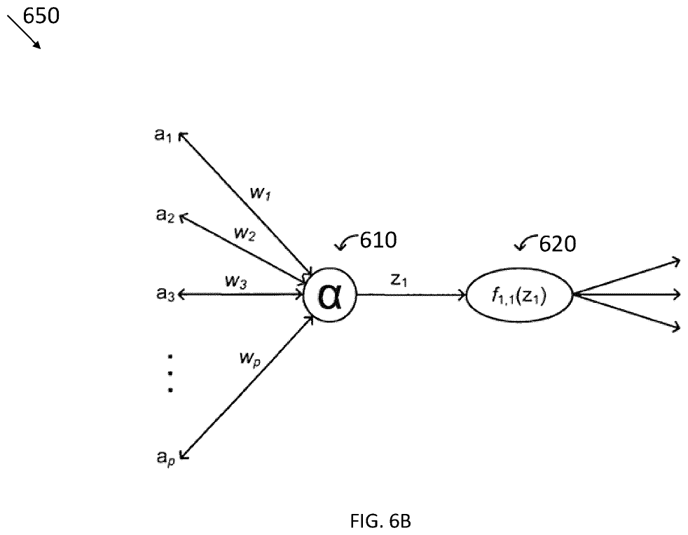

FIG. 6A depicts an example artificial neural network model 600. The blockage inference ML model 242 may be implemented with one or more artificial neural network model 600. The neural network model 600 includes layers of neurons 602, 604-1 to 604-n , and 606, including an input layer 602, one or more hidden layers 604-1 through 604-n , and an output layer 606. Each layer may include any number of neurons, i.e., q, r, and n in FIG. 5A may be any positive integer. It should be understood that neural networks of a different structure and configuration from that depicted in FIG. 6A may be used to achieve the methods and systems described herein.

In the example embodiment, input layer 602 may receive different input data. For example, input layer 602 includes a first input a1 representing training images, a second input a2 representing patterns identified in the training images, a third input a3 representing edges of the training images, and so on. Input layer 602 may include thousands or more inputs. In some embodiments, the number of elements used by neural network model 600 changes during the training process, and some neurons are bypassed or ignored if, for example, during execution of the neural network, they are determined to be of less relevance.

In the example embodiment, each neuron in hidden layer(s) 604-1 through 604-n processes one or more inputs from input layer 602, and/or one or more outputs from neurons in one of the previous hidden layers, to generate a decision or output. Output layer 606 includes one or more outputs each indicating a label, confidence factor, weight describing the inputs, and/or an output image. In some embodiments, however, outputs of neural network model 600 are obtained from a hidden layer 604-1 through 604-n in addition to, or in place of, output(s) from the output layer(s) 606.

In some embodiments, each layer has a discrete, recognizable function with respect to input data. For example, if n is equal to 3, a first layer analyzes the first dimension of the inputs, a second layer the second dimension, and the final layer the third dimension of the inputs. Dimensions may correspond to aspects considered strongly determinative, then those considered of intermediate importance, and finally those of less relevance.

In other embodiments, the layers are not clearly delineated in terms of the functionality they perform. For example, two or more of hidden layers 604-1 through 604-n may share decisions relating to labeling, with no single layer making an independent decision as to labeling.

FIG. 6B depicts an example neuron 650 that corresponds to the neuron labeled as “1,1” in hidden layer 604-1 of FIG. 5A, according to one embodiment. Each of the inputs to neuron 650 (e.g., the inputs in input layer 602 in FIG. 6A) is weighted such that input a1 through ap corresponds to weights w1 through wp as determined during the training process of neural network model 600.

In some embodiments, some inputs lack an explicit weight, or have a weight below a threshold. The weights are applied to a function α (labeled by a reference numeral 610), which may be a summation and may produce a value z1 which is input to a function 620, labeled as f1,1(z1). Function 620 is any suitable linear or non-linear function. As depicted in FIG. 5B, function 620 produces multiple outputs, which may be provided to neuron(s) of a subsequent layer, or used as an output of neural network model 600. For example, the outputs may correspond to index values of a list of labels, or may be calculated values used as inputs to subsequent functions.

It should be appreciated that the structure and function of neural network model 600 and neuron 650 depicted are for illustration purposes only, and that other suitable configurations exist. For example, the output of any given neuron may depend not only on values determined by past neurons, but also on future neurons.

Neural network model 600 may include a convolutional neural network (CNN), a deep learning neural network, a reinforced or reinforcement learning module or program, or a combined learning module or program that learns in two or more fields or areas of interest. Supervised and unsupervised machine learning techniques may be used. In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. Neural network model 600 may be trained using unsupervised machine learning programs. In unsupervised machine learning, the processing element may be required to find its own structure in unlabeled example inputs. Machine learning may involve identifying and recognizing patterns in existing data in order to facilitate making predictions for subsequent data. Models may be created based upon example inputs in order to make valid and reliable predictions for novel inputs.

Additionally or alternatively, the machine learning programs may be trained by inputting sample data sets or certain data into the programs, such as images, object statistics, and information. The machine learning programs may use deep learning algorithms that may be primarily focused on pattern recognition, and may be trained after processing multiple examples. The machine learning programs may include Bayesian Program Learning (BPL), voice recognition and synthesis, image or object recognition, optical character recognition, and/or natural language processing—either individually or in combination. The machine learning programs may also include natural language processing, semantic analysis, automatic reasoning, and/or machine learning.

Based upon these analyses, neural network model 600 may learn how to identify characteristics and patterns that may then be applied to analyzing image data, model data, and/or other data. For example, neural network model 600 may learn to identify features in a series of data points.

FIG. 7 is a block diagram of an example computing device 700. The autonomy computing system 200 may be implemented with one or more computing device 700. Computing device 700 includes a processor 702 and a memory device 704. The processor 702 is coupled to the memory device 704 via a system bus 708. The term “processor” refers generally to any programmable system including systems and microcontrollers, reduced instruction set computers (RISC), complex instruction set computers (CISC), application specific integrated circuits (ASIC), programmable logic circuits (PLC), and any other circuit or processor capable of executing the functions described herein. The above examples are example only, and thus are not intended to limit in any way the definition or meaning of the term “processor. ”

In the example embodiment, the memory device 704 includes one or more devices that enable information, such as executable instructions or other data (e.g., sensor data), to be stored and retrieved. Moreover, the memory device 704 includes one or more computer readable media, such as, without limitation, dynamic random access memory (DRAM), static random access memory (SRAM), a solid state disk, or a hard disk. The memory device 704 stores, without limitation, application source code, application object code, configuration data, additional input events, application states, assertion statements, validation results, or any other type of data. The computing device 700, may also include a communication interface 706 that is coupled to the processor 702 via system bus 708. Moreover, the communication interface 706 is communicatively coupled to data acquisition devices.

In the example embodiment, processor 702 may be programmed by encoding an operation using one or more executable instructions and providing the executable instructions in the memory device 704. The processor 702 is programmed to select a plurality of measurements that are received from data acquisition devices.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those provided herein. For example, it is contemplated that executing or performing a particular operation before, contemporaneously with, or after another operation is within the scope of aspects of the disclosure.

An example technical effect of the methods, systems, and apparatus described herein includes at least one of: (a) using heuristic data including contextual data to detect blockage of lanes when the blockage is at least partially occluded from a field view of at least one sensor; (b) weighting the heuristic data using a neural network model; or (c)using a neural network model to detect the blockage based on the heuristic data.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain provided components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the provided functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the provided methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to provide that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to provide at least one of X, at least one of Y, and at least one of Z.

The provided systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An autonomous vehicle, comprising:
at least one sensor configured to capture heuristic data about an environment in which the autonomous vehicle is operating, the heuristic data including contextual data about a blockage caused by one or more blocked lanes in the environment while the one or more blocked lanes are at least partially occluded from at least one field of view of the at least one sensor;
at least one memory device configured to store machine executable instructions; and
at least one processor coupled to the at least one memory device and, upon executing the machine executable instructions, configured to:
receive the heuristic data captured by the at least one sensor;
determine, using a blockage inference machine learning (ML) model, the one or more blocked lanes exists, with the heuristic data as inputs; and
initiate a maneuver of the autonomous vehicle around the one or more blocked lanes.

2. The autonomous vehicle of claim 1, wherein the at least one processor is further configured to:
weight, using the blockage inference ML model, the heuristic data.

3. The autonomous vehicle of claim 1, wherein the heuristic data include traffic data around the autonomous vehicle in an ego lane along which the autonomous vehicle is traveling, data of construction signage, and/or data of the one or more blocked lanes.

4. The autonomous vehicle of claim 3, wherein the traffic data include turn signal states of traffic in the ego lane, trajectories of traffic vehicles, speed of traffic relative to a speed limit of the environment, and/or the speed of traffic relative to traffic in at least one adjacent lane.

5. The autonomous vehicle of claim 1, wherein the blockage inference ML model includes a sequence of perceptron layers.

6. The autonomous vehicle of claim 1, wherein the blockage inference ML model includes a rectified linear unit layer and/or a dropout layer.

7. The autonomous vehicle of claim 1, wherein the at least one memory device is further configured to:
compute, using the blockage inference ML model, at least one blockage metric; and
initiate the maneuver based on the at least one blockage metric.

8. The autonomous vehicle of claim 7, wherein the at least one memory device is further configured to:
compute the at least one blockage metric including at least one of a distance metric or a velocity metric.

9. The autonomous vehicle of claim 1, wherein the blockage inference ML model is trained with training data annotated by an operator while a training autonomous vehicle drives past a blockage.

10. The autonomous vehicle of claim 9, wherein the training data are annotated by:
labeling one or more blocked lanes causing the blockage on real-time display of the environment.

11. A computer-implemented method for detecting one or more blocked lanes for an autonomous vehicle, comprising:
receiving heuristic data captured by at least one sensor of an autonomous vehicle, the heuristic data being about an environment in which the autonomous vehicle is operating, the heuristic data including contextual data about a blockage caused by one or more blocked lanes in the environment while the one or more blocked lanes are at least partially occluded from at least one field of view of the at least one sensor;
determining, using a blockage inference machine learning (ML) model, that one or more blocked lanes exists, with the heuristic data as inputs; and
initiating a maneuver of the autonomous vehicle around the one or more blocked lanes.

12. The method of claim 11 further comprising weighting, using the blockage inference ML model, the heuristic data.

13. The method of claim 11, wherein the heuristic data include traffic data around the autonomous vehicle in an ego lane along which the autonomous vehicle is traveling, data of construction signage, and/or data of the one or more blocked lanes.

14. The method of claim 13, wherein the traffic data include turn signal states of traffic in the ego lane, trajectories of traffic vehicles, speed of traffic relative to a speed limit of the environment, and/or the speed of traffic relative to traffic in at least one adjacent lane.

15. The method of claim 11, wherein the blockage inference ML model includes a sequence of perceptron layers.

16. The method of claim 11, wherein the blockage inference ML model includes a rectified linear unit layer and/or a dropout layer.

17. The method of claim 11 further comprising:
computing, using the blockage inference ML model, at least one blockage metric; and
initiating the maneuver based on the at least one blockage metric.

18. The method of claim 17, wherein the computing the at least one blockage metric further comprises:
computing the at least one blockage metric including at least one of a distance metric or a velocity metric.

19. The method of claim 11 further comprising:
training the blockage inference ML model with training data annotated by an operator while a training autonomous vehicle drives past a blockage.

20. The method of claim 19, wherein the training data are annotated by:
labeling one or more blocked lanes causing the blockage on real-time display of the environment.
